(19) United States
(12) Patent Application Publication
(10) Pub. No.: US 2026/0328792 A1
(43) Pub. Date: Oct. 22, 2026

(54) Sample Handling System for Laboratory Automation System

(71) Applicant: ABB Schweiz AG, Baden (CH)

(72) Inventors: Max Novotny, Groß-Zimmern (DE); Dirk Walther, Friedberg (DE); Till Noesselt, Karlsruhe (DE)

(73) Assignee: ABB Schweiz AG, Baden (CH)

(21) Appl. No.: 19/675,817

(22) Filed: May 13, 2026

Related U.S. Application Data
(63) Continuation of application No. PCT/EP2023/083685, filed on Nov. 30, 2023.

(51) Int. Cl. G01N 35/00; G01N 35/10

(52) U.S. Cl. CPC G01N 35/0099; G01N 35/00584; G01N 35/1065

(57) ABSTRACT

A sample handling system for a laboratory automation system includes an operating table having a plurality of regions, at least one sample tube rack for holding a sample tube for a sample detection, a sample handling device that pretreats the sample, and a robot arm that transfers the sample tube or the sample tube rack between the plurality of regions and/or between one of the plurality of regions of the operating table and a sample processing and/or analyzing system arranged outside the operating table. Each of the robot arm, the sample tube rack and the sample handling device is arranged in one or more of the plurality of regions.

### CROSS-REFERENCE TO RELATED APPLICATIONS

The instant application claims priority to International Patent Application No. PCT/EP2023/083685, filed Nov. 30, 2023, which is incorporated herein in its entirety by reference.

### FIELD OF THE DISCLOSURE

The present disclosure relates to a sample handling system and method for a laboratory automation system.

### BACKGROUND OF THE INVENTION

In a conventional analytical laboratory, biological samples are collected, labelled, pretreated using, for example, a centrifuge and subsequently sorted while preparing for an analytical detection. Typically, the sample preparation may be performed manually by a medical technical assistant. A modern analysis laboratory equipped with a full-scale automated sample preparation workflow is highly desired to be developed.

### BRIEF SUMMARY OF THE INVENTION

The present disclosure relates to a sample handling system for a laboratory automation system, a laboratory automation system for analyzing a plurality of samples, the use of a sample handling system for automatically preparing and/or pretreating at least one sample to be detected by at least one sample processing and/or analyzing system in a laboratory automation system, the use of a laboratory automation system for an automated sample analysis and diagnostics, a method for automatically operating a laboratory automation system, a computer program, a non-transitory machine readable data carrier and/or a download product with the computer program, and one or more computers and/or compute instances with the computer program and/or with the machine-readable data carrier and/or download product.

It may be seen as an objective of the invention to provide a sample preparation system following an efficiently and well-controlled sample preparation process for sample diagnostics and detection.

According to a first aspect of the present disclosure, a sample handling system is provided for a laboratory automation system. The sample handling system comprises an operating table, which comprises a plurality of regions, at least one robot arm, at least one sample tube rack and at least one sample handling device. The at least one sample tube rack is configured to hold at least one sample tube for a sample detection for at least one sample to be detected. The at least one sample handling device is configured to pretreat the at least one sample for the sample detection. Each of the at least one robot arm, the at least one sample tube rack and the at least one sample handling device is arranged in one or more of the plurality of regions on the operating table. The at least one robot arm is configured to transfer the at least one sample tube or the at least one sample tube rack between the plurality of regions and/or between one of the plurality of regions of the operating table and a sample processing and/or analyzing system being arranged outside the operating table.

### BRIEF DESCRIPTION OF THE SEVERAL VIEWS OF THE DRAWINGS

Examples of the disclosure will be described in the following with reference to the following drawings.

FIG. 1 shows schematically a perspective view of an example of a sample handling system for a laboratory automation system according to the present disclosure;

FIG. 2 shows schematically a perspective view of an example of a sample handling system for a laboratory automation system according to the present disclosure;

FIG. 3 shows schematically a top view of an example of a sample handling system for a laboratory automation system according to the present disclosure;

FIG. 4 shows schematically a top view of an example of a laboratory automation system according to the present disclosure; and

FIG. 5 shows schematically a flow chart illustrating a method for automatically unloading an object by means of an unloading system according to the present disclosure.

The figures are merely schematic representations and serve only to illustrate examples of the disclosure. Identical or equivalent elements are in principle provided with the same reference signs.

### DETAILED DESCRIPTION OF THE INVENTION

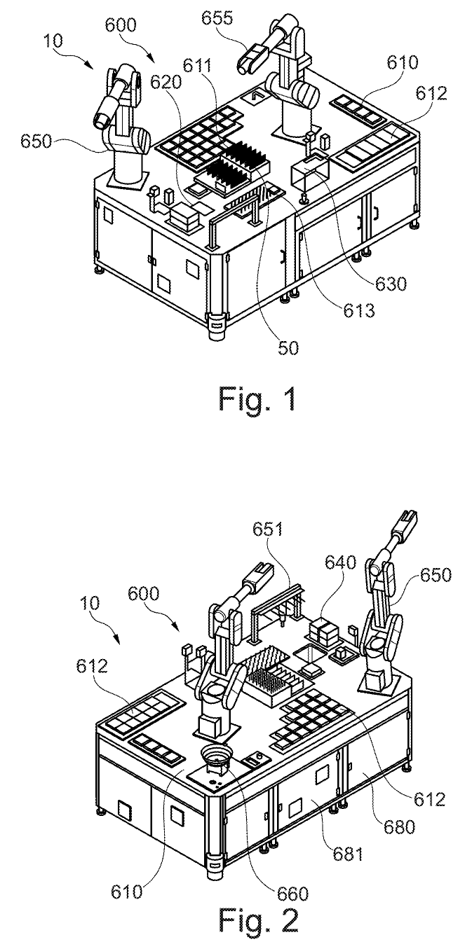

FIGS. 1 and 2 show, respectively, a schematic perspective view of an example of a sample handling system 600 for a laboratory automation system 10.

The sample handling system 600 comprises an operating table 610, which comprises a plurality of regions, at least one robot arm 650, at least one sample tube rack 50 and at least one sample handling device 620.

In order to perform a sample detection for at least one sample to be detected, the at least one sample tube rack 50 may be configured to hold at least one sample tube. The at least one sample rube rack 50 can thus comprise at least one opening that may be configured to accommodate the at least one sample tube, each of which may comprise a sample prepared for the sample analysis or sample detection.

For example, the sample to be detected may be a biological sample. In particular, the sample to be detected may be, but not limited to, a blood sample, a tissue biopsies sample, a saliva sample, a cerebrospinal fluid sample, a sputum sample or a bone marrow sample.

The at least one sample handling device 620 may be configured to pretreat the at least one sample for the sample detection. For example, the at least one sample handling device 620 may be configured to a centrifuge, a shaker, an incubator, a mixer for mixing the collected sample with a reagent, or a sample sorting device for sorting the sample for various sample detections, for example, based on the type of the sample or based on a cover color of the sample tube indicative of the type of the sample.

For example, the centrifuge 620 may be designed as an under-table centrifuge built into the table 610, so that samples, such as blood samples, may be automatically collected, scanned, centrifuged and sorted, when the samples may need to be centrifuged prior to the sample detection.

The at least one robot arm 650 comprises, as an example shown in FIGS. 1 and 2, two robot arms, namely a first robot arm and a second robot arm, which may be arranged or mounted in two different regions on the operating table 610. In other words, the first and second robot arms 650 are distributed on the operating table 610 and are configured to cover various reach areas.

Each of the at least one robot arm 650, the at least one sample tube rack 50 and the at least one sample handling device 620 may be arranged in one or more of the plurality of regions.

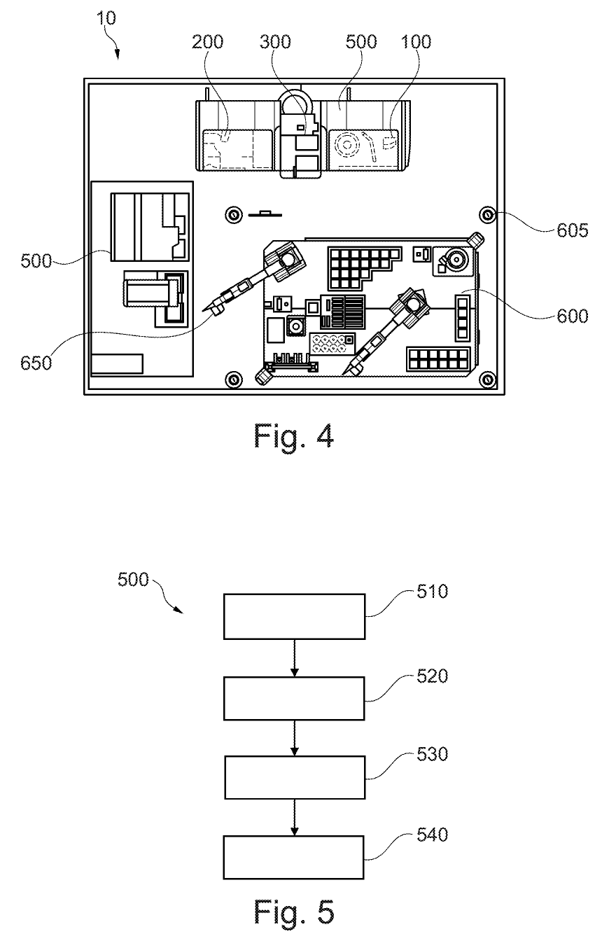

The at least one robot arm 650 may be configured to transfer the at least one sample tube or the at least one sample tube rack 50 between the plurality of regions within the operating table 610, and/or between one of the plurality of regions of the operating table 610 and a sample processing and/or analyzing system 500, as shown in FIG. 4, which may be arranged outside the operating table 610 and within reach of one the at least one robot arm 650, such as the first robot arm.

For example, the at least one sample tube rack 50 may comprise a single sample tube rack, which may be designed to be loaded into the at least one processing and/or analyzing system by means of the first robot arm 650.

Each of the first and second robot arms 650 may comprise a gripper 655, which may be, but not limited to, a vacuum gripper, a magnetic gripper, a pneumatic gripper, an adhesive gripper, a gecko gripper, a mechanical gripper or a bio-inspired gripper. For example, the first robot arm may comprise a first gripper and the second robot arm may comprise a second gripper. The first gripper and the second gripper may comprise the same or a different shape, size or type of gripper.

Each of the first and second grippers 655 may be designed to be replaceable and configured to be storable in one or more of the plurality of regions on the operating table 610. Further, the sample handling system 600 may further comprise at least one gripper holding unit 651, which may be arranged on the operating table 610 and configured to hold a plurality of grippers, so that the gripper, in particular the first gripper or the gripper, may be replaced when being out of use.

In the laboratory automation system 10 with the sample handling system 600, as shown in FIG. 4, it may be provided that the first robot arm 650 is arranged within a distance from one or more of the at least one sample processing and/or analyzing system 500 and configured to transfer the first sample tube rack 50 between a first region 611 out of the plurality of regions at the operating table 610 and the sample processing and/or analyzing system 500 for loading the first sample tube rack 50 into or unloading the first sample tube rack 50 from the at least one sample processing and/or analyzing system 500. The first region 611 may be arranged within reach of the first robot arm.

The second robot arm may be configured to prepare and/or transfer the first sample tube rack 50 to the first region 611 of the plurality of regions within the operating table 610.

As such, the first and second robot arms 650 may be configured, respectively, to perform different tasks and collaborate with each other in an efficient way for pretreating, handling and transporting the sample for the sample preparation.

As shown in FIGS. 1 and 2, at least one sample holding unit 612 may be provided including one or more sample holding units that may be distributed in one or more regions of the plurality of regions on the operating table 610. For example, the samples to be detected may be arranged in one of the sample holding units in a second region as a sample receiving region as shown in FIG. 1. Additionally, as shown in FIG. 2, the samples being already detected may be arranged in another sample holding unit 612 in a third region on an opposite side of the second robot arm compared to the samples to be detected.

Additionally, the sample handling system 600 in FIG. 1 further comprises a sample identifying device 630, which is arranged on the operating table 610 next to the sample receiving region with the sample holding unit 612. The sample identifying device 630 may be configured to identify the at least one sample tube or the at least one sample tube rack 50. The sample identifying device 630 may be, for example, a scanning device, which may be configured to scan and detect a cap color, a shape of the at least one sample tube, a fill level of the at least one sample tube, a fill coverage of the at least one sample tube rack 50 and/or a label comprising parameter data of the at least one sample for loading into the at least one sample tube.

Further, the sample handling system may further comprise at least one reagent storing unit 613, which may be arranged in one or more of the plurality of regions on the operating table 610 and configured to supply at least one reagent for the at least one sample to be detected.

Using the highly integrated, multi-functional sample handling system 600, it may require a user or a technical assistant to come to replenish one or more reagents in the reagent storing unit 613, for example once a day. The sample detection of the blood samples to be detected may be performed in an automated way without the presence of the medical technical assistant and his manual operation for the rest of the sample preparation workflow. Additionally, the replenishment of the at least one reagent may further be automated, for example, by arranging a fill level sensor in the vicinity of the at least one reagent storing unit. Once the fill level sensor detects that the fill level of the reagent may exceed a fill level minimum, the sample handling system 600 may be configured to replenish the reagent by refilling the reagent storing unit 613 from an external reagent container.

The automated sample handling device 600 may allow an efficient and economic sample analysis or detection even for a small or medium-sized hospital, for example, having up to 350 beds in the hospital, without being affected by the shortage of skilled personnel.

FIG. 2 shows further that the sample handling system 600 may comprise a quality control unit 640 and an archiving managing unit 660 that may be configured to insert an archiving plug to the sample tubes being detected.

Moreover, the sample handling system 600 may further comprise a control system 681, which may be arranged inside a housing 680 under the operating table 610. The control system 681 may be configured to activate the at least one robot arm 650 in a predefined sequence and/or by means of at least one motion sensor.

The operating table 610 may be arranged on a table frame supporting the operating table. Alternatively, the operating table 610 may be integrated with the table frame and the housing to form an operating station for the sample handling or operation. The housing 680 and the operating table 610 may be designed as an integral assembly for mounting the at least one robot arms 650, the at least one sample tube rack 50 and the at least one sample handling device 620, the sample identifying device 630, the quality control unit 640, the archiving managing unit 660 on the upper outer table surface of the operating table 610, while mounting the control system 681 inside the lower inner volume of the housing 680.

The motion sensor may be configured to detect the motion of the first and/or second robot arms 650. For example, it may be provided that, when the motion of the second robot arm may be detected to move from the second region towards the first region 611 of the operating table 610 to transport the sample tube rack 50 to the first region 611, the control system 681 may prevent the first robot arm by moving towards the first region 611. Once the motion sensor of the second robot arm may be detected to move away from the first region 611, the control system may allow the first robot arm moving towards the first region 611 for grasping or picking up the sample tube rack 50 and for transferring the sample tube rack 50 towards the sample processing and/or analyzing system 500.

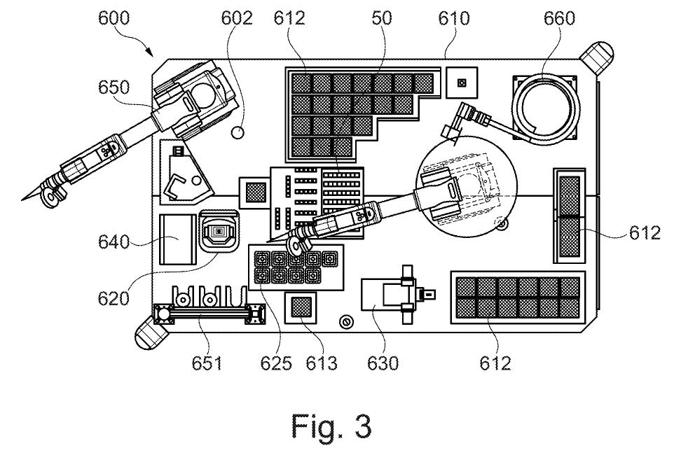

Additionally, FIG. 3 further shows that the sample handling system 600 may further comprise at least one signal indicator 602, which may be arranged in at least one or more of the plurality of regions on the operating table 610 and configured to indicate at least one operating status of the at least one robot arm 650 and/or the at least one sample handling device 620.

Each of the at least one robot arm 650, in particular the first robot arm and the second robot arm, and the at least one sample handling device 620 may be provided with a corresponding signal indicator 602 in the vicinity of the respective robot arm or sample handling device. Once the signal indicate may indicate that the robot arm 650 or the sample handling device 620 is in operation, the respective region or operating region may be blocked from a manual operation, and the user or the technical assistant may not enter into the respective operating region. This may increase the safety by operating the sample handling system 600.

Additionally, the sample handling system 600 may further comprise a safety sensor (not shown) that may be configured to detect a presence of the user in a vicinity of the sample handling system 600, or between the sample handling system 600 and sample processing and/or analyzing system 500. The safety sensor may then be configured to allow switching the sample handling system 600 from an automated operation mode to a manual operation mode, when the presence of the user is detected. Alternatively, or additionally, the safety sensor may be arranged on the operating table 610 and configured to allow one of more of the at least one robot arm 650 to be safely controlled down.

Additionally, the sample handling system 600 may further comprise at least one emergency stop button 605, which may be configured to allow manually deactivating the sample handling system 600. As shown in FIG. 4, four emergency stop buttons may be arranged outside the operating table 610, in particular, laterally to the four corners of the operating table 610, providing a safety protection for the user or the technical assistant around the sample handling system 600 and the laboratory automation system 10.

FIG. 4 shows further schematically an example of the laboratory automation system 10 for analyzing a plurality of samples, in particular a biological sample such as a blood sample. The laboratory automation system 10 comprises a sample handling system that comprises two robot arms 650, and at least one sample processing and/or analyzing system 500, which may be a blood sample analyzing system and arranged within reach of one of the two robot arms 650, for example, the first robot arm of the sample handling system 600. The sample handling system 600 may be configured to prepare at least one sample tube rack 50 for at least one sample to be detected.

The at least one robot arm 650 of the sample handling system 600 may be configured to automatically load the at least one sample tube rack 50 into or unload the at least one sample tube rack 50 from the at least one sample processing and/or analyzing system 500.

Further, the at least one robot arm 650 may be arranged at least 800 mm distant from the at least one sample processing and/or analyzing system 500, so that the at least one sample processing and/or analyzing system 500 may still be manually operatable.

FIG. 4 shows a flow chat illustrating an embodiment of a method 505 for automatically operating a laboratory automation system 10.

In step 510, a sample handling system 600 is provided which comprises an operating table 610, on which at least one robot arm 650, at least one sample tube rack 50 and at least one sample handling device 620 are arranged.

In step 520, the at least one sample is prepared for the sample detection in the at least one sample tube rack 50 by pretreating the at least one sample by means of the at least one sample handling device 620, and the at least one sample tube rack 50 is transferred between a plurality of regions within the operating table 610 by means of the at least one robot arm 650.

In step 530, the at least one sample tube rack 50 is loaded into a sample processing and/or analyzing system 500 by transferring the at least one sample tube rack 50 between the operating table 610 and the sample processing and/or analyzing system 500 by means of the at least one robot arm 650.

The method 505 may further comprise the step 540, in which the at least one sample tube rack 50 is unloaded from the sample processing and/or analyzing system 500 to the sample handling system 600 by transferring the at least one sample tube or the at least one sample tube rack 50 by means of the at least one robot arm 650.

Additionally, the method 505 may further comprise the step of performing the sample detection by means of the at least one sample processing and/or analyzing system 500 between the step 530 of the loading the at least one sample tube rack 50 into the sample processing and/or analyzing system 500 and the step 540 of the unloading the at least one sample tube rack 50 from the sample processing and/or analyzing system 500 back to the sample handling system 600.

In the context of the present disclosure, the at least one sample tube rack may comprise a single sample tube rack or a plurality of sample tube racks.

The sample handling system may be configured to automatically activate the at least one robot arm and/or at least one sample handling device, alternately or simultaneously, so that the analytical detection for the samples prepared in the sample tubes in the single sample tube rack or in the plurality of the sample tube rack may be loaded into the sample processing and/or analyzing system by being transferred using the at least one robot arm, which may be fixed or mounted onto the operating table and able to reach the sample processing and/or analyzing system.

According to an embodiment, the at least one sample handling device may be a centrifuge, a shaker, an incubator, a mixer or a sample sorting device.

The at least one sample handling device may not be limited to the above listed devices. The term “sample handling device” may be understood broadly and may relate to a device that may be designed for the proper manipulation, pretreatment, or processing of samples in a laboratory or other analytical or diagnostic system. Each sample handling device may serve a specific function in collecting, storing, processing and transfer of the at least one sample.

For example, the centrifuge may be designed as an under-table centrifuge built into the table, so that samples, such as blood samples, may be automatically collected, scanned, centrifuged and sorted, when the samples may need to be centrifuged prior to the sample detection in the sample processing and/or analyzing system.

According to another embodiment, the at least one robot arm may comprise a first robot arm, which may comprise a first gripper, and a second robot arm, which may comprise a second gripper. Each of the first gripper and the second gripper may be replaceable and configured to be storable in one or more of the plurality of regions on the operating table.

In other words, each of the at least one robot arm may comprise a gripper, which may be, but not limited to, a vacuum gripper, a magnetic gripper, a pneumatic gripper, an adhesive gripper, a gecko gripper, a mechanical gripper or a bio-inspired gripper.

The first gripper and the second gripper may comprise the same or a different shape, size or type of gripper.

For example, the sample handling system may further comprise a gripper holding unit, which may be arranged in one or more of the plurality of the regions on the operating table and configured to hold a plurality of grippers, so that the gripper, in particular the first gripper or the second gripper, may be replaced when being out of use.

According to another embodiment, the at least one sample tube rack may comprise a single sample tube rack, which may be designed to be loaded into the at least one processing and/or analyzing system by means of the first robot arm.

Alternatively, the at least one sample tube rack may comprise a plurality of sample tube racks. Multiple sample tube racks may be loaded into the at least one processing and/or analyzing system by means of the first robot arm.

The sample handling system may be configured to determine whether the single sample tube rack or multiple sample tube racks may be loaded into the processing and/or analyzing system, for example, depending on the detection capacity or detection settings of the processing and/or analyzing system.

According to another embodiment, the first robot arm may be arranged within a distance from the sample processing and/or analyzing system and configured to transfer the first sample tube rack between a first region out of the plurality of regions at the operating table and the sample processing and/or analyzing system for loading or unloading the first sample tube rack. The second robot arm may be configured to prepare and/or transfer the first sample tube rack to the first region of the plurality of regions within the operating table.

The first robot arm and the second robot arm may be assigned to different tasks and configured, respectively, to collaborate with each other. For example, the second robot arm may be configured to transfer the first sample tube rack from a second region of the plurality of regions, which may be arranged distant from the sample processing and/or analyzing system, to the first region, which may be arranged within reach of the first robot arm. The first robot arm may be arranged to further transfer or transport the first sample tube rack from the first region to the sample processing and/or analyzing system for the sample detection or analysis.

According to another embodiment, the at least one sample may be, but not limited to, a blood sample, a tissue biopsies sample, a saliva sample, a cerebrospinal fluid sample, a sputum sample or a bone marrow sample. The at least one sample may thus be at least one biological sample.

According to another embodiment, the sample handling system further comprises a control system, which may be arranged in a housing under the operating table. The control system may be configured to control or activate the at least one robot arm in a predefined sequence and/or automatically by means of at least one motion sensor.

The operating table may be arranged on a table frame supporting the operating table. Alternatively, the operating table may be integrated with the table frame and the housing to form an operating station for the sample handling or operation.

The housing and the operating table may be designed as an integral assembly for mounting the at least one robot arm, the at least one sample tube rack and the at least one sample handling system on the upper outer table surface of the operating table, while mounting the control system inside the lower inner volume of the housing.

The motion sensor may be configured to detect the motion of the first robot arm and/or the second robot arm. For example, it may be provided that, when the motion of the second robot arm may be detected to move from the second region towards the first region of the operating table to transport the sample tube rack to the first region, the control system may prevent the first robot arm by moving towards the first regions. Once the motion sensor of the second robot arm may be detected to move away from the first region, the control system may allow the first robot arm to move towards the first region for grasping or picking up the sample tube rack and for transferring the sample tube rack towards the sample processing and/or analyzing system.

For example, the sample handling system may further comprise at least one a sample holding unit comprising one or more sample holding units, which may be distributed in one or more regions of the plurality of regions on the operating table. For example, blood samples may be arranged in the second region of the operating table as a sample receiving region.

According to another embodiment, the sample handling system may further comprise at least one sample identifying device, which may be arranged in one or more of the plurality of regions on the operating table and configured to identify the at least one sample tube or the at least one sample tube rack.

The term of sample identifying device may be understood broadly and may relate to a device in the laboratory system that may assess and determine the properties and characterizing parameters of a sample to be detected.

According to another embodiment, the at least one sample identifying device is a scanning device, configured to scan and detect a cap color, a shape of the at least one sample tube, a fill level of the at least one sample tube, a fill coverage of the at least one sample tube rack and/or a label comprising parameter data of the at least one sample for loading into the at least one sample tube.

According to another embodiment, the sample handling system may further comprise at least one reagent storing unit, which may be arranged in one or more of the plurality of regions on the operating table and configured to supply at least one reagent for the at least one sample to be detected.

The term of reagent for the laboratory analysis or detection may be understood broadly and may relate to a chemical substance or compound used in laboratory procedures to elicit a specific reaction by mixing with a biological sample or facilitate the detection of a particular component in the sample.

Advantageously, by using the sample handling device of the present disclosure, the medical technical assistant may come to replenish one or more reagents, for example once a day. The sample detection of the blood samples to be detected may be performed in an automated way without the presence of the medical technical assistant and his manual operation for the rest of the sample preparation workflow. Additionally, the replenishment of the at least one reagent may further be automated, for example, by arranging a fill level sensor in the vicinity of the at least one reagent storing unit. Once the fill level sensor detects that the fill level of the reagent may exceed a fill level minimum, the sample handling system may be configured to replenish the reagent by refilling the reagent storing unit from an external reagent container.

Further, the automated sample handling device may allow an efficient and economic sample analysis or detection even for a small or medium-sized hospital, for example, having up to 350 beds in the hospital, without being affected by the shortage of skilled personnel.

According to another embodiment, the sample handling system may further comprise at least one signal indicator, which may be arranged in one or more of the plurality of regions on the operating table and configured to indicate at least one operating status of the at least one robot arm and/or the at least one sample handling device.

Each of the at least one robot arm, in particular the first robot arm and the second robot arm, and the at least one sample handling device may be provided with a corresponding signal indicator in the vicinity of the respective robot arm or sample handling device. Once the signal indicate may indicate that the robot arm or the sample handling device is in operation, the respective region or operating region may be blocked from a manual operation, and the technical assistant may not enter into the respective operating region.

According to another embodiment, the sample handling system may further comprise a safety sensor, which may be configured to detect a presence of a user in a vicinity of the sample handling system or between the sample handling system and sample processing and/or analyzing system. The safety sensor may be configured to allow switching the sample handling system from an automated operation mode to a manual operation mode, when the presence of the user is detected. Alternatively, or additionally, the safety sensor may be arranged on the operating table, which may be configured to allow one of more of the at least one robot arm to be safely controlled down.

According to another embodiment, sample handling system may further comprise at least one emergency stop button, which may be configured to allow manually deactivating the sample handling system. The at least one emergency stop button may be arranged on the operating table or outside the operating table. For example, the at least one emergency stop button may be arranged laterally relative to the one or more of the four corners of the operating table to provide a round safety protection for the user or the technical assistant.

According to a second aspect, a laboratory automation system is provided for analyzing a plurality of samples. The sample handling system comprises a sample handling system of the present disclosure, which comprises at least one robot arm, and at least one sample processing and/or analyzing system. The at least one sample processing and/or analyzing system is arranged within reach of the at least one robot arm of the sample handling system. The sample handling system is configured to prepare at least one sample tube rack for at least one sample to be detected. The at least one robot arm of the sample handling system is configured to automatically load the at least one sample tube rack into or unload the at least one sample tube rack from the at least one sample processing and/or analyzing system.

According to an embodiment, the sample processing and/or analyzing system is a blood sample analyzing system. For example, the sample to be detected may be a blood sample. Alternatively, or additionally, the sample to be detected may be, but not limited to, a tissue biopsies sample, a saliva sample, a cerebrospinal fluid sample, a sputum sample or a bone marrow sample. Accordingly, the sample processing and/or analyzing system may be an analyzing system for the respective sample.

According to another embodiment, the at least one robot arm may be arranged at least 800 mm distant from the at least one sample processing and/or analyzing system, so that the at least one sample processing and/or analyzing system may be manually operatable. It may be important that safety sensors may be arranged on or outside an operating table of the handling system, allowing the at least one robot arm to be safely controlled down. This means that the sample handling device or machine may be placed down and may not need to be enclosed.

According to a third aspect, the use of a sample handling system is provided for automatically preparing and/or pretreating at least one sample to be detected by at least one sample processing and/or analyzing system in a laboratory automation system.

According to a fourth aspect, the use of a laboratory automation system is provided for an automated sample analysis and diagnostics.

According to a fifth aspect, a method is provided for automatically operating a laboratory automation system. The method comprises the following steps: providing a sample handling system comprising an operating table, on which at least one robot arm, at least one sample tube rack and at least one sample handling device are arranged; preparing the at least one sample for the sample detection in the at least one sample tube rack by pretreating the at least one sample by means of the at least one sample handling device and transferring the at least one sample tube or the at least one sample tube rack between a plurality of regions within the operating table by means of the at least one robot arm; loading the at least one sample tube or the at least one sample tube rack into a sample processing and/or analyzing system by transferring the at least one sample tube or the at least one sample tube rack between the operating table and the sample processing and/or analyzing system by means of the at least one robot arm.

According to an embodiment, the method may further comprise the step of unloading the at least one sample tube or the at least one sample tube rack from the sample processing and/or analyzing system to the sample handling system by transferring the at least one sample tube or the at least one sample tube rack by means of the at least one robot arm.

Additionally, for example, the method may further comprise the step of performing the sample detection by means of the at least one sample processing and/or analyzing system between the step of the loading the at least one sample tube or the at least one sample tube rack into the sample processing and/or analyzing system and the step of the unloading the at least one sample tube or the at least one sample tube rack from the sample processing and/or analyzing system back to the sample handling system.

According to another aspect, there is provided a computer program that comprises machine-readable instructions that, when executed by one or more computers and/or compute instances, cause the one or more computers and/or compute instances to perform a method for automatically operating a laboratory automation system.

According to another aspect, there is provided a non-transitory machine-readable data carrier and/or a download product with the computer program. A download product is an instance of the computer program that may be sold and downloaded online for immediate fulfilment in lieu of physically shipping a machine-readable data carrier.

According to another aspect, there are provided one or more computers and/or compute instances with the computer program comprising machine-readable instructions that, when executed by one or more computers and/or compute instances, cause the one or more computers and/or compute instances to perform a method for automatically operating a laboratory automation system, and/or with the machine-readable data carrier and/or download product with the computer program.

The method may be at least partly computer-implemented, and may be implemented in software or in hardware, or in software and hardware. Further, the method may be carried out by computer program instructions running on means that provide data processing functions. The data processing means may be a suitable computing means, such as an electronic control module etc., which may also be a distributed computer system. The data processing means or the computer, respectively, may comprise one or more of a processor, a memory, a data interface, or the like.

It should be noted that the above examples may be combined with each other irrespective of the aspect involved. Accordingly, the method may be combined with structural features and, likewise, the apparatus and the system may be combined with features described above with regard to the method.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

10 laboratory automation system

50 sample tube rack

500 sample processing and/or analyzing system

600 sample handling system

602 signal indicator

605 emergency stop button

610 operating table

611 first region

612 sample holding unit

613 reagent storing unit

620 sample handling device

630 sample identifying device

640 quality control unit

650 robot arm

651 gripper holding unit

655 gripper

660 archiving managing unit

680 housing

681 control system

505 method for automatically operating a laboratory automation system

510 step of providing a sample handling system

520 step of preparing the at least one sample for the sample detection

530 step of loading sample tube or sample tube rack into sample processing and/or analyzing system

540 unloading sample tube or sample tube rack from sample processing and/or analyzing system

What is claimed is:

1. A sample handling system for a laboratory automation system, comprising:
an operating table comprising a plurality of regions;
at least one robot arm;
at least one sample tube rack configured to hold at least one sample tube for a sample detection for at least one sample to be detected;
at least one sample handling device configured to pretreat the at least one sample for the sample detection;
wherein each of the at least one robot arm the at least one sample tube rack and the at least one sample handling device is arranged in one or more of the plurality of regions on the operating table;
wherein the at least one robot arm is configured to transfer the at least one sample tube or the at least one sample tube rack between the plurality of regions and/or between one of the plurality of regions of the operating table and a sample processing and/or analyzing system being arranged outside the operating table.

2. The sample handling system according to claim 1, wherein the at least one sample handling device is a centrifuge, a shaker, an incubator, a mixer or a sample sorting device.

3. The sample handling system according to claim 1, wherein the at least one robot arm comprises a first robot arm comprising a first gripper, and a second robot arm comprising a second gripper; and wherein each of the first gripper and the second gripper is replaceable and configured to be storable in one or more of the plurality of regions on the operating table.

4. The sample handling system according to claim 3, wherein the at least one sample tube rack comprises a single sample tube rack configured to be loaded into the at least one processing and/or analyzing system using the first robot arm.

5. The sample handling system according to claim 4, wherein the first robot arm is arranged within a distance from the sample processing and/or analyzing system and is configured to transfer the first sample tube rack between a first region out of the plurality of regions at the operating table and the sample processing and/or analyzing system for loading or unloading the first sample tube rack; wherein the second robot arm is configured to prepare and/or transfer the first sample tube rack to the first region of the plurality of regions within the operating table.

6. The sample handling system according to claim 1, wherein the at least one sample is a blood sample, a tissue biopsies sample, a saliva sample, a cerebrospinal fluid sample, a sputum sample, or a bone marrow sample.

7. The sample handling system according to claim 1, further comprising a control system arranged in a housing under the operating table; wherein the control system is configured to activate the at least one robot arm in a predefined sequence and/or based on signals from at least one motion sensor.

8. The sample handling system according to claim 1, further comprising at least one sample identifying device arranged in one or more of the plurality of regions on the operating table and configured to identify the at least one sample tube or the at least one sample tube rack.

9. The sample handling system according to claim 8, wherein the at least one sample identifying device is a scanning device configured to scan and detect at least one of a cap color, a shape of the at least one sample tube, a fill level of the at least one sample tube, a fill coverage of the at least one sample tube rack, and/or a label comprising parameter data of the at least one sample for loading into the at least one sample tube.

10. The sample handling system according to claim 1, further comprising at least one reagent storing unit arranged in at least one or more of the plurality of regions on the operating table and configured to supply at least one reagent for the at least one sample to be detected.

11. The sample handling system according to claim 1, further comprising at least one signal indicator arranged in at least one or more of the plurality of regions on the operating table and configured to indicate at least one operating status of the at least one robot arm and/or the at least one sample handling device.

12. The sample handling system according to claim 1, further comprising a safety sensor configured to detect a presence of a user in a vicinity of the sample handling system or between the sample handling system and the sample processing and/or the analyzing system; wherein the safety sensor is configured to allow switching the sample handling system from an automated operation mode to a manual operation mode, when the presence of the user is detected.

13. The sample handling system according to claim 1, further comprising at least one emergency stop button configured to allow manually deactivating the sample handling system.

14. A laboratory automation system for analyzing a plurality of samples, comprising:
a sample handling system comprising:
an operating table comprising a plurality of regions;
at least one robot arm;
at least one sample tube rack configured to hold at least one sample tube for a sample detection for at least one sample to be detected;
at least one sample handling device configured to pretreat the at least one sample for the sample detection;
wherein each of the at least one robot arm the at least one sample tube rack and the at least one sample handling device is arranged in one or more of the plurality of regions on the operating table;
wherein the at least one robot arm is configured to transfer the at least one sample tube or the at least one sample tube rack between the plurality of regions and/or between one of the plurality of regions of the operating table and at least one sample processing and/or analyzing system being arranged outside the operating table;
wherein the at least one sample processing and/or analyzing system is arranged within reach of the at least one robot arm of the sample handling system;
wherein the sample handling system is configured to prepare at least one sample tube rack for at least one sample to be detected; and
wherein the at least one robot arm of the sample handling system is configured to automatically load the at least one sample tube rack into or unload the at least one sample tube rack from the at least one sample processing and/or analyzing system.

15. The laboratory automation system according to claim 14, wherein the at lest one sample processing and/or analyzing system is a blood sample analyzing system.

16. The laboratory automation system according to claim 15, wherein the at least one robot arm is arranged at least 800 mm away from the at least one sample processing and/or analyzing system so that the at least one sample processing and/or analyzing system is manually operatable.

17. A method for automatically operating a laboratory automation system, comprising:
providing a sample handling system comprising an operating table on which at least one robot arm, at least one sample tube rack, and at least one sample handling device are arranged;
preparing the at least one sample for the sample detection in the at least one sample tube rack by pretreating the at least one sample using the at least one sample handling device, and transferring the at least one sample tube or the at least one sample tube rack between a plurality of regions within the operating table using the at least one robot arm; and
loading the at least one sample tube or the at least one sample tube rack into a sample processing and/or analyzing system by transferring the at least one sample tube or the at least one sample tube rack between the operating table and the sample processing and/or analyzing system using the at least one robot arm.

18. The method according to claim 17, further comprising unloading the at least one sample tube or the at least one sample tube rack from the sample processing and/or analyzing system to the sample handling system by transferring the at least one sample tube or the at least one sample tube rack using the at least one robot arm.

19. Computer program, comprising machine-readable instructions that, when executed by one or more computers and/or compute instances, cause the one or more computers and/or compute instances to perform a method for automatically operating a laboratory automation system, comprising:
instructions for providing a sample handling system comprising an operating table on which at least one robot arm, at least one sample tube rack, and at least one sample handling device are arranged;
instructions for preparing the at least one sample for the sample detection in the at least one sample tube rack by pretreating the at least one sample using the at least one sample handling device, and transferring the at least one sample tube or the at least one sample tube rack between a plurality of regions within the operating table using the at least one robot arm; and
instructions for loading the at least one sample tube or the at least one sample tube rack into a sample processing and/or analyzing system by transferring the at least one sample tube or the at least one sample tube rack between the operating table and the sample processing and/or analyzing system using the at least one robot arm.

20. The computer program according to claim 19, further comprising instructions for unloading the at least one sample tube or the at least one sample tube rack from the sample processing and/or analyzing system to the sample handling system by transferring the at least one sample tube or the at least one sample tube rack using the at least one robot arm.
